(19) United States
(12) Patent Application Publication
(10) Pub. No.: US 2014/0156852 A1
(43) Pub. Date: Jun. 5, 2014

(54) METHOD AND SYSTEM FOR SHARING TESTING RESOURCES THROUGH THE WEB

(71) Applicant: Ilyong Moon, Seoul (KR)

(72) Inventor: Ilyong Moon, Seoul (KR)

(73) Assignee: ONYCOM, INC., Seoul (KR)

(21) Appl. No.: 14/232,261

(22) PCT Filed: Oct. 25, 2011
(86) PCT No.: PCT/KR2011/007982

§ 371 Date: Jan. 11, 2014

(30) Foreign Application Priority Data
Jul. 12, 2011 (KR) 10-2011-0069036

(51) Int. Cl. H04L 12/911

(52) U.S. Cl. CPC H04L 47/70
USPC 709/226

(57) ABSTRACT

The present invention relates to a method, and to a system, for sharing testing resources through the Web. The system comprises: a web server connected by at least one user terminal through a network, and consisting of a unit for managing device information and a client communication unit; a proxy server connected by at least one user terminal through a network, and consisting of a controller, a display controlling unit, a setting controlling unit, and an event controlling unit; at least one electronic terminal connected so as to communicate with the proxy server; and a database for storing device information on the electronic terminal and state information on a device. The controller extracts device information and device state information on each electronic terminal from the respective electronic terminals, and pushes same to the unit for managing device information. The unit for managing device information unit stores the pushed device information and device state information on each electronic device in the database, transmits the device information and device state information on each electronic terminal to the web server communication unit, receives a request for use for an electronic terminal selected from the web server communication unit, and approves the use to the web server communication unit by referring to the state information of the selected electronic terminal stored in the database. The controller is connected by a proxy server communication unit of the user terminal that has been approved for use, and performs testing on the selected electronic terminal.

### TECHNICAL FIELD

The present invention relates to a method and system for sharing testing resources via the web and, more particularly, to a method and system by which a plurality of users can utilize various testing resources through web service.

### BACKGROUND ART

Recently, information technology (IT) has rapidly developed, and various types of hardware modules have been mounted on a single electronic terminal. In particular, with the acceleration of a digital convergence phenomenon in which a new service or product is created by the convergence of various digital-based products or services, various Operating Systems (OSs) capable of operating individual electronic terminals have been commercialized.

In this situation, software developers have a high degree of freedom that enables them to develop numerous applications for using hardware resources included in the electronic terminals, but also have the burden of developing and testing applications that can be executed on various hardware and platforms without any problem.

Korean Patent Application Publication No. 10-2004-0077639 discloses a technology for providing a test method to an electronic terminal. This technology enables a developer to be provided with test results, obtained from a wireless communication terminal that moves to various places, in real time even without directly visiting all the places. This technology enables communication with an electronic terminal at a remote location, but is limited in the stable sharing of testing resources on various types of hardware and various platforms.

### DISCLOSURE

### Technical Problem

Accordingly, the present invention has been made keeping in mind the above problems occurring in the prior art, and an object of the present invention is to provide a web-based environment that enables developers to test applications at the same time in an environment including various types of hardware and various platforms.

Another object of the present invention is to provide a method and system that enable a plurality of developers to share testing resources in a plurality of electronic terminals in a more stable and reliable web-based environment.

### Technical Solution

In order to accomplish the above objects, the present invention provides a method of sharing testing resources via a web, comprising the steps of: (a) extracting, by a control unit of a proxy server, device information and device state information of each electronic terminal from one or more electronic terminals, and pushing, by the control unit of the proxy server, the device information and the device state information to a device information management unit of a web server; (b) storing, by the device information management unit, the pushed device information and device state information of each electronic terminal in a database; (c) sending, by the device information management unit, the device information and device state information of each electronic terminal to a web server communication unit of a user terminal, and receiving, by the device information management unit, a request for use of a selected electronic terminal from the web server communication unit; (d) allowing, by the device information management unit, the web server communication unit to use the selected electronic terminal while referring to the state information of the selected electronic terminal that is stored in the database; and (e) performing, by the control unit being accessed by a communication unit of the proxy server of the user terminal allowed to be used, testing on the selected electronic terminal.

The present invention provides a system for sharing testing resources via a web, including a web server configured to be accessed by one or more user terminals over a network, and to comprise a device information management unit and a client communication unit; a proxy server configured to be accessed by the one or more user terminals over the network, and to comprise a control unit, a display management unit, an installation management unit, and an event management unit; one or more electronic terminals connected to the proxy server through communication; and a database configured to store device information and device state information of the electronic terminals; wherein the control unit extracts device information and device state information of each electronic terminal from the one or more electronic terminals, and pushes the device information and device state information to the device information management unit; wherein the device information management unit stores the pushed device information and device state information of each electronic terminal in the database, sends the device information and device state information of each electronic terminal to the web server communication unit, receives a request for use of a selected electronic terminal from the web server communication unit, and allows the web server communication unit to use the selected electronic terminal while referring to the state information of the selected electronic terminal that is stored in the database; and wherein the control unit is accessed by a communication unit of the proxy server of the user terminal allowed to be used and performs testing on the selected electronic terminal.

### Advantageous Effects

In accordance with the present invention, the present invention can provide a web-based environment that enables developers to test applications in an environment including various types of hardware and various platforms.

Furthermore, the present invention can provide a method and system that enable a plurality of developers to share testing resources in a plurality of electronic terminals in a more stable and reliable web-based environment.

### DESCRIPTION OF DRAWINGS

FIG. 1 is a diagram illustrating a system for sharing testing resources via the web.

FIG. 2 is a flowchart illustrating a method of sharing testing resources via the web. FIG. 3 is a block diagram illustrating the construction of a web server in the present invention.

FIG. 4 is a block diagram illustrating the construction of a proxy server in the present invention.

FIG. 5 is a diagram illustrating the construction of a browser displayed on a user terminal in the present invention.

### MODE FOR INVENTION

A method and system for sharing testing resources via the web according to embodiments of the present invention will be described in detail below with reference to the drawings. The advantages and characteristics of the present invention and the methods for achieving the advantages and characteristics thereof will become more apparent from the embodiments that will be described in detail below in conjunction with the accompanying drawings.

However, the present invention is not limited to the embodiments disclosed below, but may be implemented in various different ways. The embodiments are provided merely to make the disclosure of the present invention complete and to enable a person having ordinary skill in the art to fully understand the scope of the present invention. The present invention is defined only by the claims.

The same reference numbers denote the same elements throughout the specification.

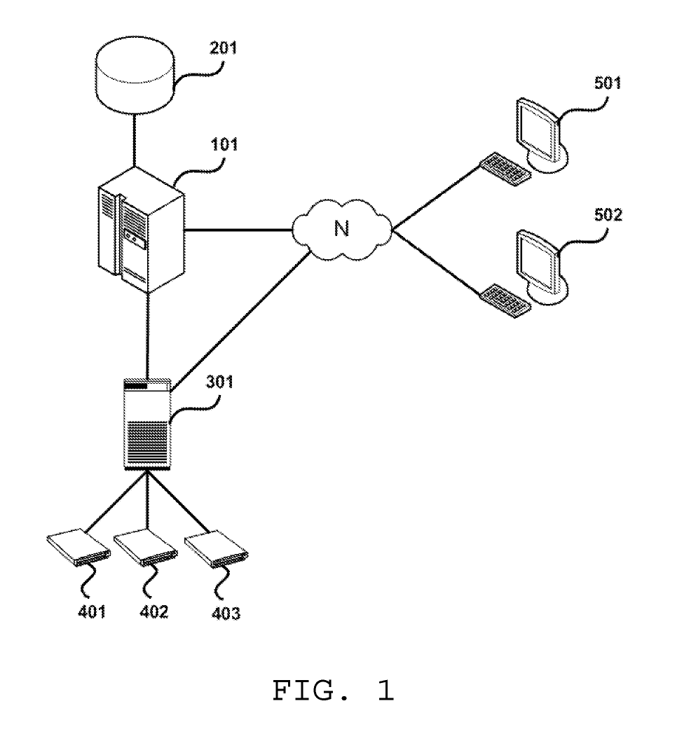

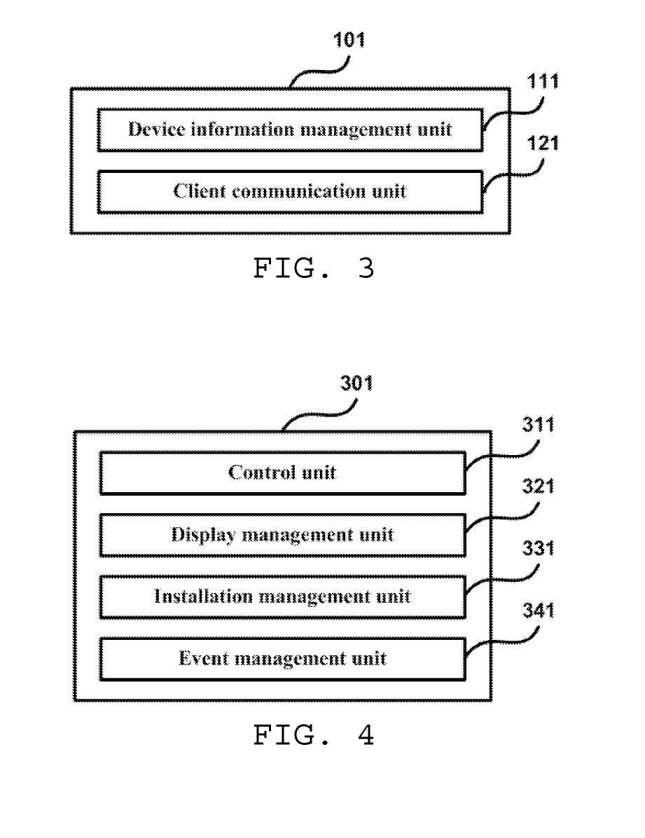

FIG. 1 is a diagram illustrating a system for sharing testing resources via the web, FIG. 3 is a block diagram illustrating the construction of a web server in the present invention, and FIG. 4 is a block diagram illustrating the construction of a proxy server in the present invention.

The present invention includes a server-side system to which one or more user terminals 501 and 502 used by developers are connected over a network N. The server-side system includes a web server 101, a database 201 for storing information, a proxy server 301 for communicating with the web server and the user terminals, and one or more electronic terminals 401, 402, and 403 connected to the proxy server via communication.

The web server 101 is a common information processing system, and includes a device information management unit 111 and a client communication unit 121. The device information management unit and the client communication unit are physically separate systems, and are implemented to perform data communication with each other. The web server 101 may be implemented as a group of systems, or the device information management unit and the client communication unit may be respective conceptual modules or processes that are executed within a single physical system. Furthermore, the web server 101 may include a load balancing server for distributing communication loads because it receives web access from the one or more user terminals 501 and 502. In particular, the device information management unit 111 receives device information and device state information for each of the electronic terminals that are connected to the proxy server 301 through communication with the control unit 311 of the proxy server 301. As described below, the device information management unit 111 may transmit and receive data using the HTTP protocol. The client communication unit 121 is a component for receiving web access from the one or more user terminals 501 and 502 and providing web service, and may be implemented as a common web daemon, etc.

The proxy server 301 is a common information processing system, and may include the control unit 311, a display management unit 321, an installation management unit 331, and an event management unit 341. These components are also physically separate systems, and are implemented to perform data communication with each other. The proxy server 301 may be implemented as a group of systems, or the components may be respective conceptual modules or processes that are executed within a single physical system. Furthermore, it will be apparent that the proxy server 301 may be implemented as a group of systems including a load balancing server for distributing communication loads because it is accessed by the one or more user terminals 501 and 502 through network communication.

A step in which the components interact with each other will be described below.

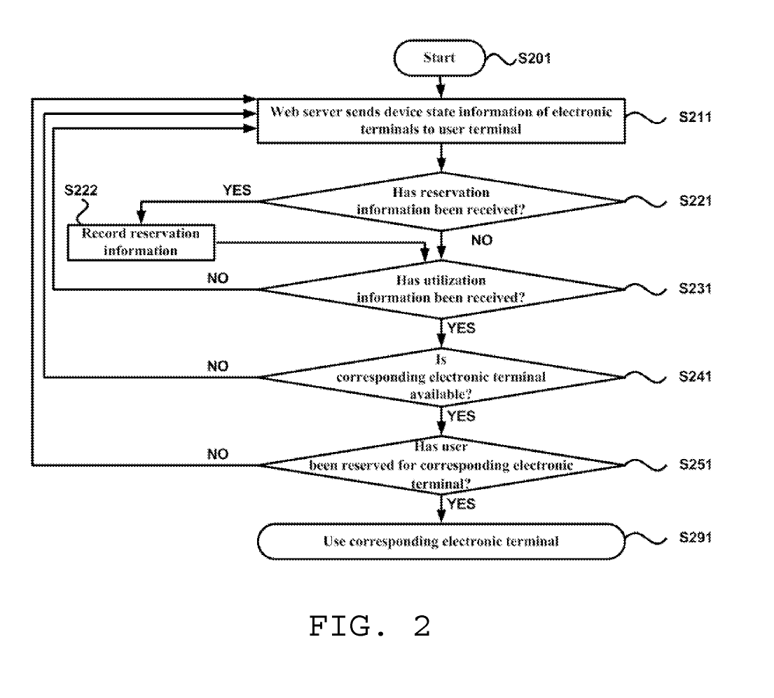

FIG. 2 is a flowchart illustrating a method of sharing testing resources via the web.

First, the electronic terminals 401, 402 and 403 having their characteristics are connected to the proxy server 301 through communication. In this case, the connection through communication may be a connection via a Universal Serial Bus (USB), or may be a connection over a common network. For example, the electronic terminals may be devices of various platforms having the following characteristics.

TABLE 1

| | HARDWARE MODEL | OS |
|---|---|---|
| 1 | Samsung Galaxy S (SHW-M110S) | Android 2.3 Gingerbread |
| 2 | Samsung Wave (GT-S8500) | Bada 1.2 |
| 3 | iPhone 3GS | iOS 4.0.1 |
| 4 | iPad wifi | iOS5 beta |

When the administrator of the server-side system connects an electronic terminal having another different characteristic to the communication connection interface of the proxy server 301, the proxy server 301 may access the OS of the added electronic terminal, and may extract information about hardware model and the OS as device information or receive the device information from the administrator of the system. Such device information of each electronic terminal is recorded in the memory or another storage space of the proxy server 301, and is pushed to the device information management unit 111 of the web server 101 by the control unit 311. Furthermore, the control unit 311 extracts the following state information as the state of each of the connected electronic terminals, and pushes the extracted state information, together with the device information, to the device information management unit 111.

TABLE 2

| No. | STATE INFORMATION | DESCRIPTION |
|---|---|---|
| 1 | Free | Not used currently (no |
| | | connected user) |
| 2 | DeviceError | Device connection error |
| 3 | NetError | Communication error |
| | | with electronic terminal |
| 4 | xx.xx.xx.xx | IP address of user |
| | | terminal now connected |

The HTTP protocol is used for communication between the control unit 311 and the device information management unit 111. If a session using the common TCP/IP is set up and used in communication therebetween, communication stability may be degraded and a development cost for such a processing module may be required. In the present invention, the device information management unit 111 is implemented using the HTTP protocol in order to implement the device information management unit 111 at a lower development cost, maximize communication stability and limit direct access to the database of the web server 101. Accordingly, the device information management unit 111 may be implemented as a module for transmitting and receiving data using the HTTP protocol, or may preferably be implemented using only a web page for processing a common web daemon and an HTTP request signal. In practice, if three electronic terminals device1, device2, and device3 are connected to the proxy server 301, an HTTP request signal transmitted from the control unit 311 to the device information management unit 111 using the device information and state information of an electronic terminal as the parameter values of a PUT method may be implemented as follows.

TABLE 3
httpConnection = Session.GetHttpConnection(“211.47.235.17”,
8083);httpFile = httpConnect−>OpenRequest(“PUT”,
“/webTestForte/setDeviceStatus.jsp”); httpFile−>SendRequest(NULL,0,
“device1=111.11.11.11&device2=Free&device3=DeviceError”, 53);

As shown above, it is preferred that access to the device information management unit 111 not be disclosed, and thus it is preferred that the access port number of the device information management unit 111 be additionally defined and used, like “8083,” except for widely known ports. The device information management unit 111 that has received such an HTTP request signal extracts the state information of each electronic terminal from the received parameter, and stores the state information in the database 201 or makes an update. The device information management unit 111 sends an HTTP response signal to the control unit 311 as a result of the storage or update. In this case, the control unit 311 recognizes whether the state information of each electronic terminal has been successfully updated by parsing the response signal, and records the results of the recognition as a log. In order to maximize security, it is preferred that the device information management unit 111 check the sender IP address of the side that has sent the HTTP request signal and the device information management unit 111 be implemented to update the pushed device information and the device state information of each electronic terminal only when the IP address of the sender is an IP address already registered with the proxy server 301. Since information about resources used in testing is abstracted through the web server 101 and access to the databases of other devices is restricted as described above, security can be improved, communication traffic can be minimized, and communication stability can be maximized.

The device information and device state information of each electronic terminal stored in the database 201 as described above are transmitted to the user terminals 501 and 502 that have accessed the client communication unit 121 at step S211. The user terminals 501 and 502 access the client communication unit 121 implemented as a web daemon through a user browser 510. A web page transmitted to the user terminals 501 and 502 through the client communication unit 121 includes a web server communication unit 511 for transmitting and receiving data to and from the client communication unit 121 and a proxy server communication unit 512 for accessing the proxy server 301 and performing testing on an electronic terminal.

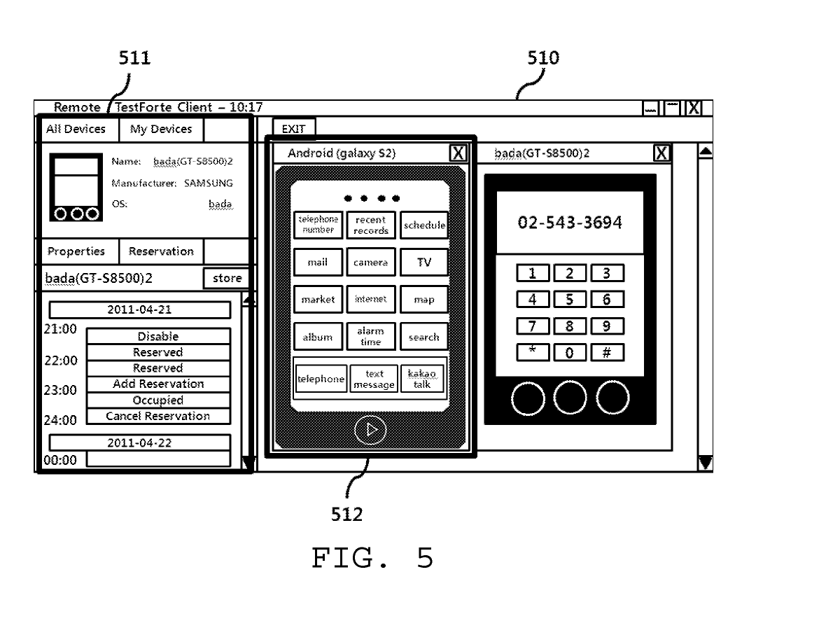

The web server communication unit 511 receives and displays the device information and device state information of each electronic terminal, as shown in FIG. 5. A user can make a reservation while referring to the displayed device information and device state information of each electronic terminal. A reservation procedure is performed in such a manner that a reservation request, including the identification number of an electronic terminal and reservation time information selected by a user, is transmitted from the web server communication unit 511 to the device information management unit 111 and is recorded in the database at steps S221 and S222. At the same time, the user may select the electronic terminal and request the electronic terminal to be used at step S231.

The control unit 311 allows the web server communication unit 511 to use the user terminal requested to be used by determining whether the electronic terminal requested to be used is now available while referring to the device state information stored in the database 201 and also determining whether the electronic terminal requested to be used has been reserved for another user while referring to reservation information at step S291. The web server communication unit 511 extracts the identification number of the corresponding electronic terminal from the device information of the corresponding electronic terminal so that the proxy server communication unit 512 accesses the proxy server 301 and testing is performed on the electronic terminal corresponding to the identification number. In this case, since a plurality of the proxy server communication units 512 may be executed through the web server communication unit 511 at the same time, a user can execute and test his or her own application on different platforms at the same time.

The testing of the electronic terminal is performed in such a manner that the proxy server communication unit 512 included in a user browser and the display management unit 321, the installation management unit 331 and the event management unit 341 included in the proxy server 301 transmit and receive data to and from each other. First, an application developed by a user may be installed in such a manner that the source file or the object file of the application are transmitted to the installation management unit 331 through the proxy server communication unit 512 and the installation management unit 331 sends the received source file or object file to a corresponding electronic terminal and stores it. The application may be installed using an installation Application Programming Interface (API) provided by the OS of the corresponding electronic terminal, like “adb.” Furthermore, the display management unit of the proxy server sends information about the screen of the electronic terminal to the proxy server communication unit 512, and the proxy server communication unit 512 displays the received screen information on the screen of the user terminal, thereby enabling performing testing in an environment, like that in which testing is performed as if the user actually viewed the corresponding electronic terminal. In order to extract the information on the screen of the corresponding electronic terminal, the display management unit 321 may use a Virtual Network Computing (VNC) module that is separately installed in and executed by the corresponding electronic terminal or an API provided by the OS of the corresponding electronic terminal. Furthermore, the event management unit 341 transfers event information, received from the proxy server communication unit 512, to the electronic terminal, so that simulation is performed. In this case, the event information includes a numerical value and information about an event type. The event type includes at least one of a cursor location event, a button input event, an event sensed by a motion sensor, an event sensed by a gyroscope sensor, and a location information reception event. For example, control may be performed such that when a user places a cursor at a specific location while viewing information about the screen of an electronic terminal displayed on the proxy server communication unit 512 through the input device of a user terminal, information about an event type and position coordinates corresponding to a cursor location event are transmitted to the event management unit 341 as event information and the event management unit 341 places the cursor of the electronic terminal at the corresponding location through an API provided by the OS of the corresponding electronic terminal. Likewise, simulation may be performed as if a corresponding electronic terminal moved through an event sensed by a motion sensor, and simulation may be performed as if a corresponding electronic terminal moved through a location information reception event.

The system log of an electronic terminal generated through the above testing process may be recorded so that a user can use the system log in debugging, and may be sent to a user terminal. Furthermore, during a testing process, a user may use a paid additional service via the corresponding electronic terminal. For example, if a user has used an additional service, such as making a phone call, using a Short Message Service (SMS), or using a payment service during the testing, the control unit may record an additional service utilization history, and may charge the user of the user terminal allowed to be used in accordance with the recorded utilization history.

When the testing is completed or the connection to the proxy server communication unit 512 is disconnected, the control unit 311 deletes the installed files used in the corresponding testing and installed on the electronic terminal, and resets the environmental configuration.

Furthermore, if a user's reservation time during which testing is now being performed on a specific electronic terminal is terminated based on reservation information, the device information management unit 111 sends a testing termination signal to the proxy server communication unit 512, thereby terminating the testing.

As described above, it will be understood by those skilled in the art to which the present invention pertains that the present invention may be implemented in other specific forms without changing the technical spirit or indispensable characteristics of the present invention. Therefore, it should be understood that the above-described embodiments are illustrative and not limitative from all aspects. The scope of the present invention is defined by the appended claims, rather than the detailed description. The present invention should be construed as covering all modifications or variations derived from the meaning and scope of the appended claims and their equivalents.

1. A method of sharing testing resources via a web, comprising the steps of:
(a) extracting, by a control unit of a proxy server, device information and device state information of each electronic terminal from one or more electronic terminals, that is, the one or more electronic terminals providing testing resources, and pushing, by the control unit of the proxy server, the device information and the device state information to a device information management unit of a web server;
(b) storing, by the device information management unit, the pushed device information and device state information of each electronic terminal in a database;
(c) sending, by the device information management unit, the device information and device state information of each electronic terminal to a user terminal, that is, the user terminal trying to share testing resources, and receiving, by the device information management unit, a request for use of a selected electronic terminal from the user terminal;
(d) allowing, by the device information management unit, the user terminal to use the selected electronic terminal while referring to the state information of the selected electronic terminal that is stored in the database; and
(e) performing, by the control unit being accessed by the user terminal allowed to be used, testing on the selected electronic terminal
wherein step (e) comprises performing the testing by performing the step of sending, by a display management unit of the proxy server, information about a screen of the selected electronic terminal to the user terminal, receiving, by an event management unit of the proxy server, event information from the user terminal, and transferring, by the event management unit of the proxy server, the event information to the selected electronic terminal.

2. (canceled)

3. The method of claim 1, wherein:
the event information comprises a numerical value and information about an event type, and the selected electronic terminal is simulated in accordance with the information about an event type, the event type comprising at least one of a cursor location event, a button input event, an event sensed by a motion sensor, an event sensed by a gyroscope sensor, and a location information reception event.

4. The method of claim 1, wherein step (e) comprises receiving, by an installation management unit of the proxy server, an installation file from the user terminal, and installing, by the installation management unit of the proxy server, the installation file on the selected electronic terminal.

5. The method of claim 1, wherein:
step (c) further comprises the step of receiving, by the device information management unit, a reservation request for use of the selected electronic terminal from the user terminal, and recording, by the device information management unit, information about the reservation in the database; and
step (d) comprises the step of allowing, by the device information management unit, the user terminal to use the selected electronic terminal while referring to the state information and reservation information of the selected electronic terminal that have been stored in the database.

6. The method of claim 5, further comprising the step of (f) sending, by the device information management unit, a testing termination signal to the user terminal being tested when a reservation time is terminated while referring to the reservation information stored in the database.

7. The method of claim 6, further comprising the step of (g) resetting, by the control unit, the state of the selected electronic terminal to an environment prior to the testing when the testing of the user terminal is terminated.

8. The method of claim 1, wherein the control unit pushes the device information and the device state information of each electronic terminal through an HTTP request signal in relation to the device information management unit.

9. The method of claim 8 wherein the control unit determines whether the device information and device state information of each electronic terminal have been successfully updated by parsing an HTTP response signal corresponding to the HTTP request signal received from the device information management unit.

10. The method of claim 8, wherein step (b) comprises storing, by the device information management unit, the pushed device information and device state information of each electronic terminal in the database only when a sender IP address of the received HTTP request signal is an IP address of the proxy server that has been previously registered.

11. The method of claim 1, further comprising step (h) of recording, by the control unit, an additional service utilization history of the electronic terminal selected in the testing process, and charging, by the control unit, a user of the user terminal allowed to be used in accordance with the additional service utilization history.

12. A system for sharing testing resources via a web, comprising:
a web server configured to be accessed by one or more user terminals, that is, the one or more user terminals trying to share testing resources, over a network, and to comprise a device information management unit and a client communication unit;
a proxy server configured to be accessed by the one or more user terminals over the network, and to comprise a control unit, a display management unit, an installation management unit, and an event management unit;
one or more electronic terminals, that is, the one or more electronic terminals providing testing resources, connected to the proxy server through communication; and
a database configured to store device information and device state information of the electronic terminals;
wherein the control unit extracts device information and device state information of each electronic terminal from the one or more electronic terminals, and pushes the device information and device state information to the device information management unit;
wherein the device information management unit stores the pushed device information and device state information of each electronic terminal in the database, sends the device information and device state information of each electronic terminal to the user terminal, receives a request for use of a selected electronic terminal from user terminal, and allows the user terminal to use the selected electronic terminal while referring to the state information of the selected electronic terminal that is stored in the database; and
wherein the control unit is accessed by the user terminal allowed to be used, and performs testing on the selected electronic terminal by allowing a display management unit to send information about a screen of the selected electronic terminal to the user terminal and allowing an event management unit to receive event information from the user terminal and to transfer the event information to the selected electronic terminal.
